(19) United States
(12) Patent Application Publication
(10) Pub. No.: US 2019/0220778 A1
(43) Pub. Date: Jul. 18, 2019

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventors: Koki MURANO, Tokyo (JP); Noriyuki MINEGISHI, Tokyo (JP); Ryo YAMAMOTO, Tokyo (JP); Yoshihiro OGAWA, Tokyo (JP); Tomomi TAKEUCHI, Tokyo (JP)

(73) Assignee: MITSUBISHI ELECTRIC CORPORATION, Tokyo (JP)

(21) Appl. No.: 16/327,112

(22) PCT Filed: Oct. 4, 2016
(86) PCT No.: PCT/JP2016/079513

§ 371 Date: Feb. 21, 2019

(51) Int. Cl. G06N 20/00; G06F 17/11; G06F 9/30; G06F 16/9035

(52) U.S. Cl. CPC G06N 20/00; G06F 16/9035; G06F 9/3001; G06F 17/11

(57) ABSTRACT

An analysis unit divides hierarchized program code into a plurality of program elements in accordance with a predetermined division condition, analyzes each of the plurality of program elements, and extracts an attribute of each program element and a hierarchy of the plurality of program elements. A functional module extraction unit performs machine learning on the basis of the attribute of each program element and the hierarchy of the plurality of program elements extracted by the analysis unit and groups the plurality of program elements into a plurality of groups.

### TECHNICAL FIELD

The present invention relates to a technique for supporting architecture design of an embedded system, for example.

### BACKGROUND ART

A system widely used in household electric appliances, business machines, and the like is generally an embedded system composed of hardware and software. The embedded system is composed of an ASIC (Application Specific Integrated Circuit) (or an FPGA (Field-Programmable Gate Array)), a processor, a memory, and the like.

In the design of the embedded system, specifications describing the processing function of the whole embedded system need to be divided into a part to be converted into hardware using an ASIC or the like and a part to be converted into software in the form of a program which is executed by the processor. This is called software/hardware function division.

It is also necessary to consider how to implement a plurality of divided functions on the embedded system to achieve desired performance, and design accordingly. This is called architecture design.

In the architecture design of an embedded system, division into software and hardware devices is conventionally performed by manually performing function division based on function models and non-functional requirements in view of the amount of computation, processing parallelism, circuit size, and the like. However, at the time of performing the architecture design, it is difficult to determine whether the architecture is an optimum architecture which satisfies the non-functional requirements. For this reason, there is fear that a situation in which the non-functional requirements are found not satisfied in a process of implementation or a process of actual equipment evaluation may occur to cause significant process rework.

Patent Literature 1 discloses a technique for software/hardware function division.

### CITATION LIST

### Patent Literature

Patent Literature 1: JP 2013-125419

### SUMMARY OF INVENTION

### Technical Problem

In architecture design, program code describing a function model of an embedded system is divided into a plurality of program elements. Each program element is assigned to a software or hardware block on the basis of attributes of the program element. Under the present circumstances, the number of operators, the number of branches, the number of loops, the number of variables, the number of data inputs and outputs, and the like, which are included in each program element, are extracted as attributes of each program element. The assignment to software and hardware blocks can also be performed on the basis of the attributes, using a technique, such as machine learning. If machine learning is used, only the number of operators, the number of branches, the number of loops, the number of variables, and the number of data inputs and outputs, which are included in each program element, are extracted as attributes of each program element under the present circumstances, and there is the problem of the incapability in effectively improving the accuracy of machine learning.

The present invention mainly aims at solving the above-described problem. That is, the present invention has its major object to improve the accuracy of machine learning by more finely analyzing a program element.

### Solution to Problem

An information processing apparatus according the present invention, includes:

an analysis unit to divide hierarchized program code into a plurality of program elements in accordance with a predetermined division condition, to analyze each of the plurality of program elements, and to extract an attribute of each program element and a hierarchy of the plurality of program elements; and a grouping unit to perform machine learning on the basis of the attribute of each program element and the hierarchy of the plurality of program elements extracted by the analysis unit and to group the plurality of program elements into a plurality of groups.

### Advantageous Effects of Invention

According to the present invention, attributes of each program element and a hierarchy of a plurality of program elements are extracted through program element analysis, and machine learning is performed on the basis of the extracted attributes of the program elements and the extracted hierarchy of the plurality of program elements. For this reason, the present invention allows improvement of the accuracy of machine learning.

### BRIEF DESCRIPTION OF DRAWINGS

FIG. 1 is a diagram illustrating an example of a functional configuration of an architecture generation apparatus according to Embodiment 1.

FIG. 2 is a diagram illustrating an example of information stored in a storage unit according to Embodiment 1.

FIG. 3 is a diagram illustrating an example of a hardware configuration of the architecture generation apparatus according to Embodiment 1.

FIG. 4 is a flowchart illustrating an example of operation of the architecture generation apparatus according to Embodiment 1.

FIG. 5 is a flowchart illustrating the example of the operation of the architecture generation apparatus according to Embodiment 1.

FIG. 6 is a view illustrating an example of function model source code according to Embodiment 1.

FIG. 7 is a chart illustrating an example of non-functional requirement information according to Embodiment 1.

FIG. 8 is a chart illustrating an example of non-functional requirement vectors according to Embodiment 1.

FIG. 9 is a chart illustrating an example of functional module information according to Embodiment 1.

FIG. 10 is a chart illustrating an example of data input-output relation information according to Embodiment 1.

FIG. 11 is a diagram illustrating an example of block candidates according to Embodiment 1.

FIG. 12 is a diagram illustrating an example of architecture candidates according to Embodiment 1.

FIG. 13 is a flowchart illustrating a procedure for machine learning using an existing architecture according to Embodiment 1.

FIG. 14 is a chart illustrating an example of function model vectors according to Embodiment 1.

FIG. 15 is a chart illustrating an example of the non-functional requirement vectors according to Embodiment 1.

FIG. 16 is a diagram illustrating an example of the existing architecture used in machine learning according to Embodiment 1.

FIG. 17 is a chart illustrating an example of a grouping result obtained through machine learning using the existing architecture according to Embodiment 1.

FIG. 18 is a chart illustrating an example of a grouping result obtained through machine learning using the existing architecture according to Embodiment 1.

FIG. 19 is a chart illustrating an example of nesting level information according to Embodiment 1.

FIG. 20 is a chart illustrating an example of nest structure information according to Embodiment 1.

FIG. 21 is a chart illustrating an example of non-functional requirement vectors after update according to Embodiment 1.

### DESCRIPTION OF EMBODIMENTS

### Embodiment 1

An embodiment of the present invention will be described below with reference to the drawings. In the following description and the drawings of the embodiment, components denoted by identical reference numerals are identical portions or corresponding portions.

*** Description of Configuration ***

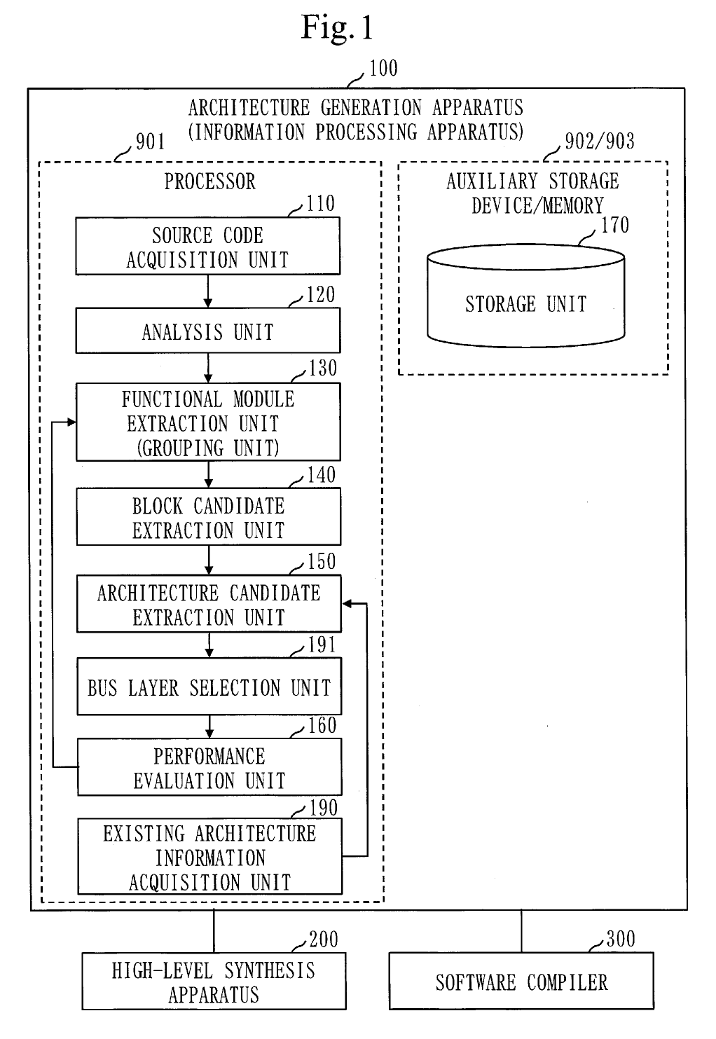

FIG. 1 illustrates an example of a functional configuration of an architecture generation apparatus 100 according to Embodiment 1. The architecture generation apparatus 100 is connected to a high-level synthesis apparatus 200 and a software compiler 300.

The architecture generation apparatus 100 is an example of an information processing apparatus. An operation to be performed by the architecture generation apparatus 100 is an example of an information processing method.

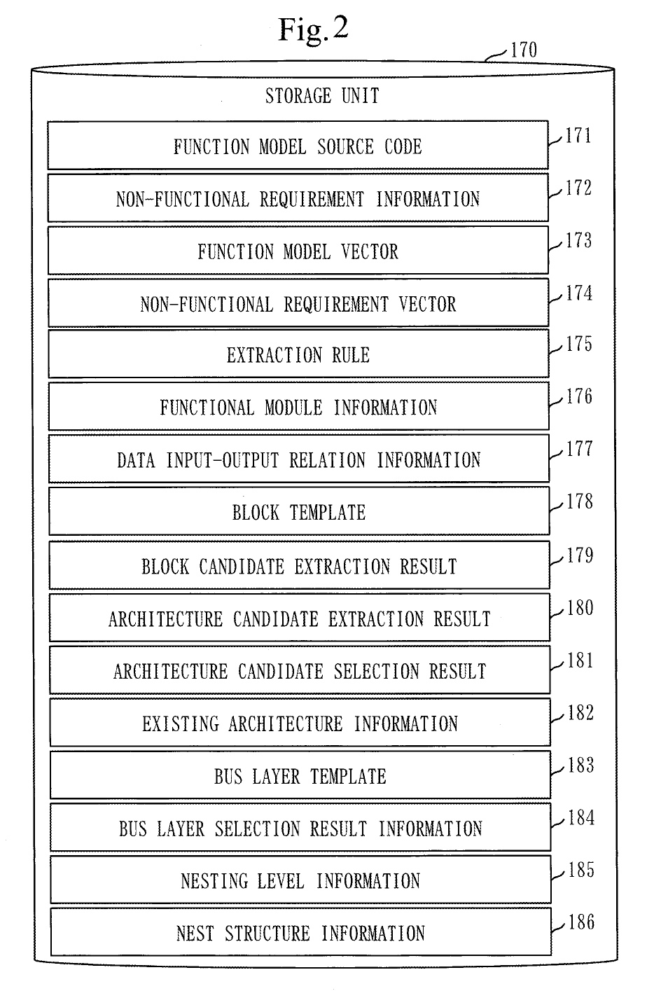

FIG. 2 illustrates information stored in a storage unit 170 inside the architecture generation apparatus 100.

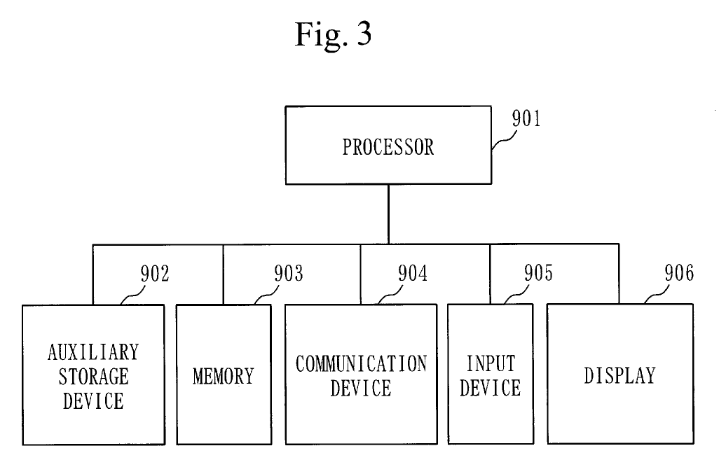

FIG. 3 illustrates an example of a hardware configuration of the architecture generation apparatus 100.

The example of the hardware configuration of the architecture generation apparatus 100 will be described first with reference to FIG. 3.

The architecture generation apparatus 100 is a computer which includes, as pieces of hardware, a processor 901, an auxiliary storage device 902, a memory 903, a communication device 904, an input device 905, and a display 906.

The auxiliary storage device 902 stores programs which implement functions of a source code acquisition unit 110, an analysis unit 120, a functional module extraction unit 130, a block candidate extraction unit 140, an architecture candidate extraction unit 150, a performance evaluation unit 160, an existing architecture information acquisition unit 190, and a bus layer selection unit 191 illustrated in FIG. 1.

The programs are loaded into the memory 903, and the processor 901 executes the programs. The processor 901 performs operation of the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191, which will be described later, by executing the programs.

FIG. 1 schematically illustrates a state in which the processor 901 is executing the programs that implement the functions of the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191.

Note that the programs that implement the functions of the analysis unit 120 and the functional module extraction unit 130 are an example of an information processing program.

The auxiliary storage device 902 functions as the storage unit 170 illustrated in FIG. 1. That is, the auxiliary storage device 902 stores the information illustrated in FIG. 2. Alternatively, the memory 903 may function as the storage unit 170 illustrated in FIG. 1. That is, the memory 903 may store the information illustrated in FIG. 2.

The communication device 904 is used when the architecture generation apparatus 100 communicates with an external apparatus. The communication device 904 includes a receiver which receives data and a transmitter which transmits data.

The input device 905 is used by a user of the architecture generation apparatus 100 to enter various types of information to the architecture generation apparatus 100.

The display 906 is used to present various types of information to the user of the architecture generation apparatus 100.

The example of the functional configuration of the architecture generation apparatus 100 will be described with reference to FIG. 1.

The source code acquisition unit 110 acquires function model source code 171 and non-functional requirement information 172 from the user via the input device 905.

The function model source code 171 and the non-functional requirement information 172 are generated by the user of the architecture generation apparatus 100.

The source code acquisition unit 110 stores the acquired function model source code 171 and non-functional requirement information 172 in the storage unit 170. FIG. 2 illustrates a state in which the function model source code 171 and the non-functional requirement information 172 are stored by the source code acquisition unit 110.

The function model source code 171 is program code describing a plurality of functions of an embedded system as an object of architecture design.

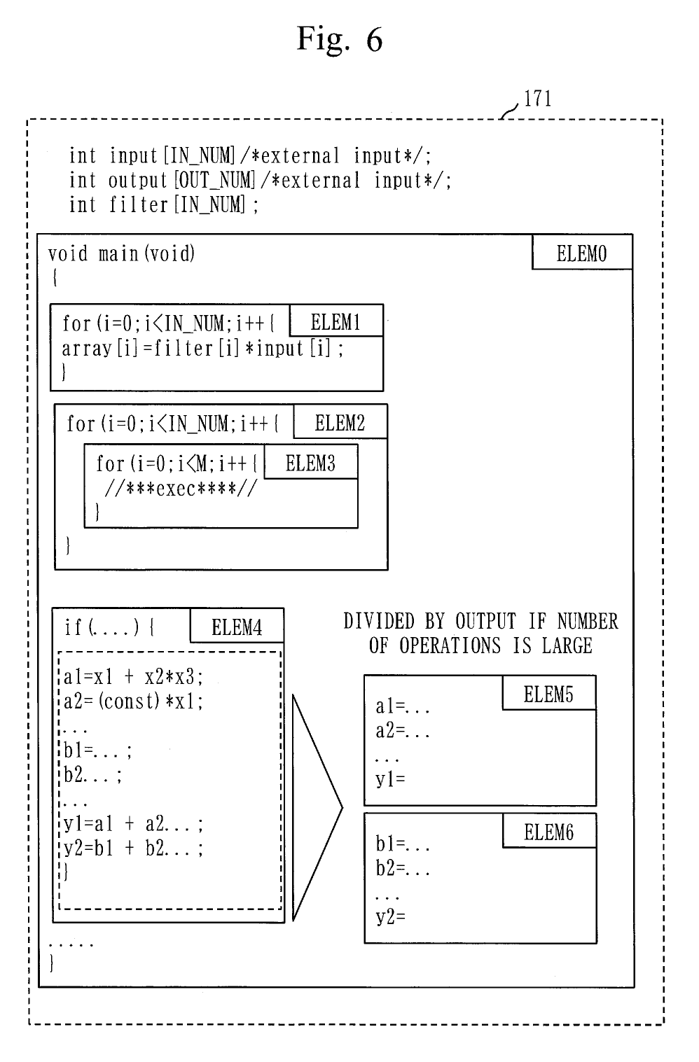

The source code acquisition unit 110 acquires, for example, the function model source code 171 illustrated in FIG. 6. Note that details of the function model source code 171 illustrated in FIG. 6 will be described later.

The non-functional requirement information 172 describes non-functional requirements which are requirements for a function described in the function model source code 171. The non-functional requirement information 172 describes, for example, a requirement associated with processing performance, a requirement associated with circuit size, and a requirement associated with power consumption.

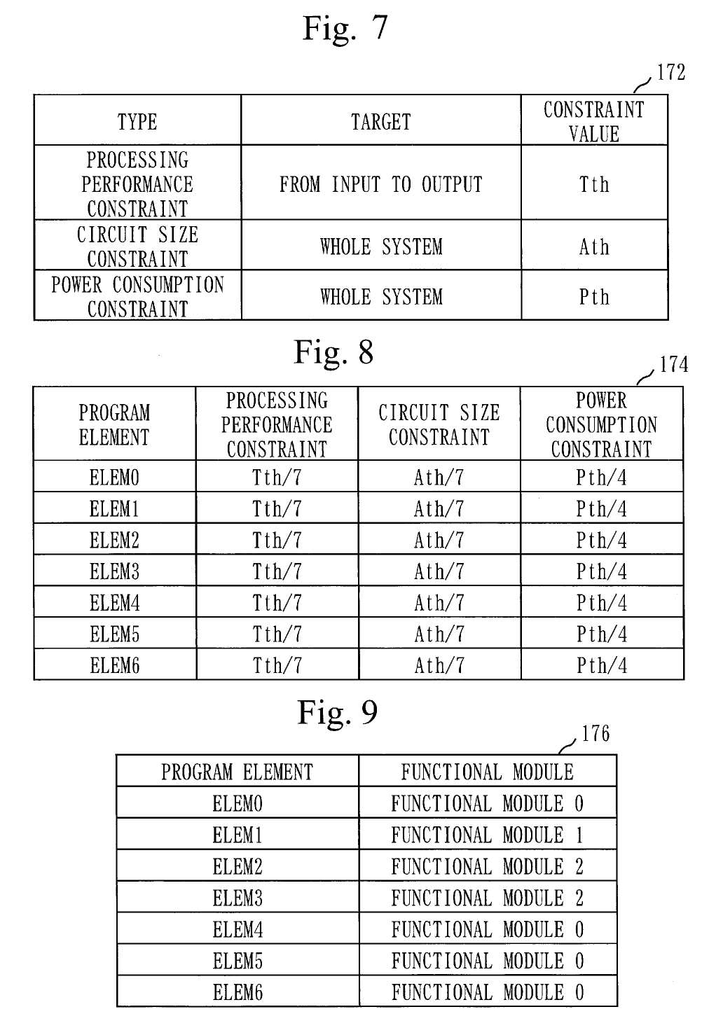

The source code acquisition unit 110 acquires, for example, the non-functional requirement information 172 illustrated in FIG. 7. Note that details of the non-functional requirement information 172 illustrated in FIG. 7 will be described later.

The analysis unit 120 divides the function model source code 171 into smallest constituent units, such as a function. A smallest constituent unit obtained through division will hereinafter be referred to as a program element. A program element is, for example, an operation which is implemented by a for loop block inside the function model source code 171. That is, content described in one for loop block can be viewed as one program element. Note that what range to define as one program element is left up to the user of the architecture generation apparatus 100. The user sets conditions for a program element in advance. The user may define, for example, one function as one program element.

The analysis unit 120 also analyzes each program element and extracts attributes of the program element. For example, the analysis unit 120 extracts the number of operators, the number of branches, and the like as attributes of the program element and generates a function model vector 173 which indicates an extraction result.

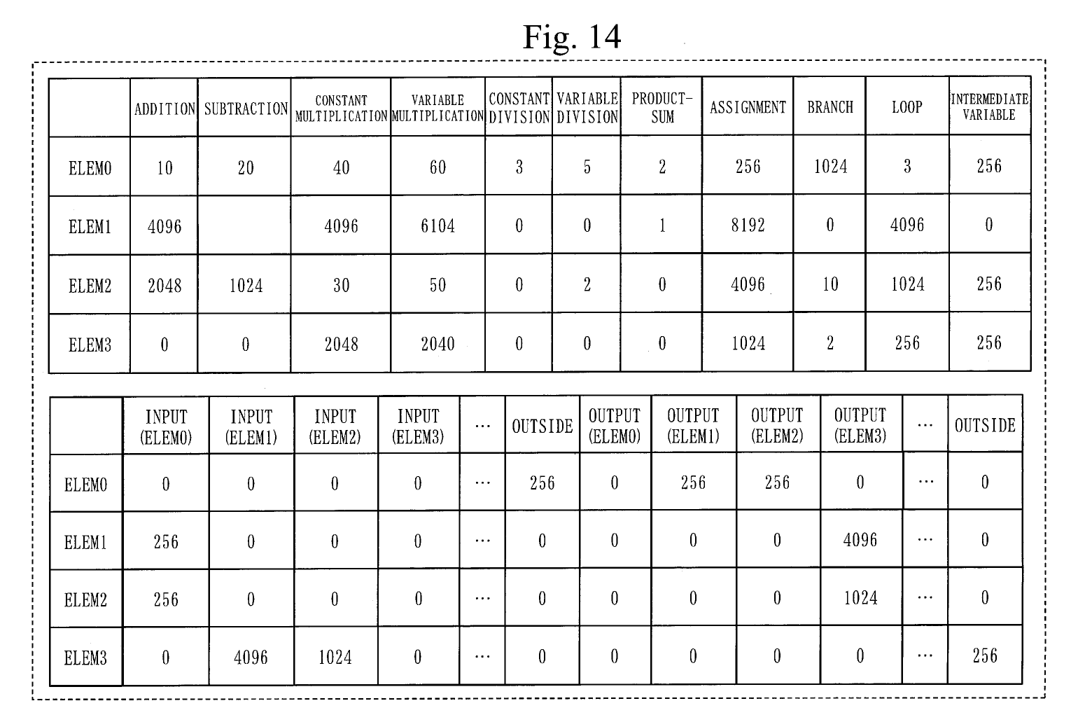

The analysis unit 120 generates, for example, the function model vectors 173 illustrated in FIG. 14. Note that details of the function model vectors 173 illustrated in FIG. 14 will be described later.

The function model source code 171 is hierarchized. That is, the function model source code 171 has a nest structure. The analysis unit 120 analyzes each program element and parameterizes the nest structure of the function model source code 171. That is, the analysis unit 120 analyzes the nest structure of the function model source code 171 and extracts a hierarchy of a plurality of program elements. The analysis unit 120 then generates nesting level information 185 and nest structure information 186 which indicate a result of the nest structure analysis. The analysis unit 120 generates, for example, the nesting level information 185 illustrated in FIG. 19 and the nest structure information 186 illustrated in FIG. 20. Details of the nesting level information 185 illustrated in FIG. 19 and the nest structure information 186 illustrated in FIG. 20 will be described later.

The analysis unit 120 divides the non-functional requirement information 172 into respective pieces for smallest constituent units, such as a function, and generates non-functional requirement vectors 174.

The analysis unit 120 generates, for example, the non-functional requirement vectors 174 illustrated in FIG. 8. Note that details of the non-functional requirement vectors 174 illustrated in FIG. 8 will be described later.

The analysis unit 120 stores, in the storage unit 170, the function model vectors 173, the nesting level information 185, the nest structure information 186, and the non-functional requirement vectors 174 that are generated. FIG. 2 illustrates a state in which the function model vectors 173, the nesting level information 185, the nest structure information 186, and the non-functional requirement vectors 174 are stored in the storage unit 170 by the analysis unit 120.

Note that an operation to be performed by the analysis unit 120 corresponds to an analysis process.

The functional module extraction unit 130 reads out, from the storage unit 170, the function model vectors 173, the nesting level information 185, the nest structure information 186, the non-functional requirement vectors 174, and extraction rules 175.

The extraction rules 175 are rules for extracting a functional module from the function model source code 171. The extraction rules 175 are rules which are obtained through machine learning.

The functional module is a collection of program elements constituting the function model source code 171. The functional module includes at least one program element among the plurality of program elements implemented by the function model source code 171.

In the present embodiment, the functional module extraction unit 130 extracts a functional module by grouping the program elements of the function model source code 171 using the function model vectors 173, the nesting level information 185, and the nest structure information 186 on the basis of the extraction rules 175.

The functional module extraction unit 130 also generates functional module information 176 which indicates a result of the functional module extraction.

The functional module extraction unit 130 generates, for example, the functional module information 176 illustrated in FIG. 9. Details of the functional module information 176 illustrated in FIG. 9 will be described later.

The functional module extraction unit 130 further analyzes a data input-output relation among functional modules indicated in the functional module information 176 on the basis of the function model vectors 173 and generates data input-output relation information 177 which indicates an analysis result.

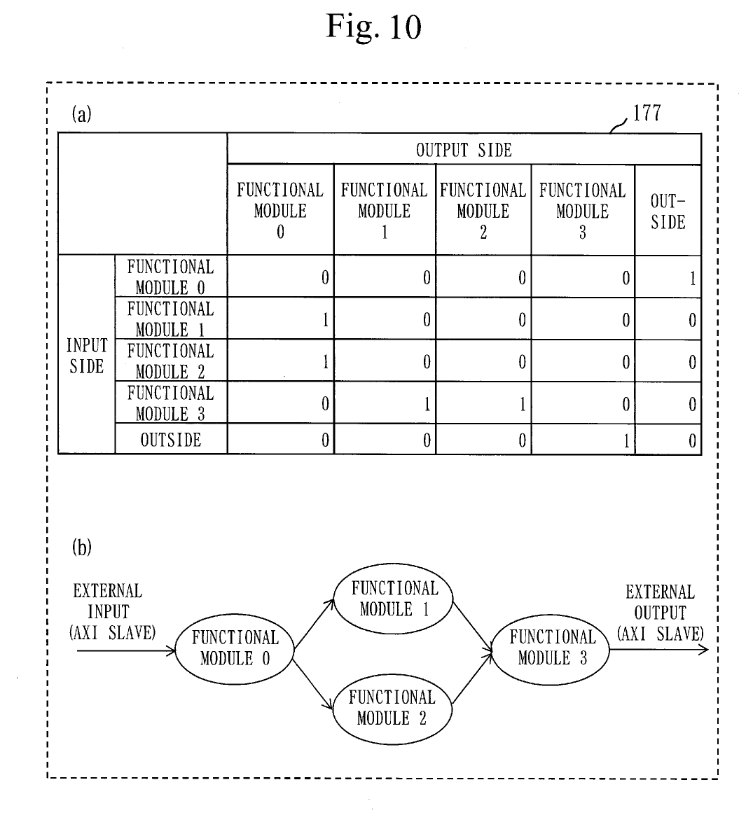

The functional module extraction unit 130 generates, for example, the data input-output relation information 177 illustrated in FIG. 10. Details of the data input-output relation information 177 illustrated in FIG. 10 will be described later.

The functional module extraction unit 130 corresponds to a grouping unit. An operation to be performed by the functional module extraction unit 130 corresponds to a grouping process.

The block candidate extraction unit 140 extracts a block candidate for each functional module.

More specifically, the block candidate extraction unit 140 designates, for each of a plurality of functional modules obtained by the functional module extraction unit 130, any one of a processor and hardware devices other than the processor as a device which implements the functional module on the basis of a block template 178. Note that a device which the block candidate extraction unit 140 assigns to each functional module is referred to as a block candidate. The block candidate extraction unit 140 also estimates the performance and the circuit size of each block candidate and excludes a block candidate which does not satisfy the non-functional requirements of the non-functional requirement information 172. That is, the block candidate extraction unit 140 designates a processor or a hardware device which satisfies the non-functional requirements as a block candidate for each functional module.

The block candidate extraction unit 140 then generates a block candidate extraction result 179 which indicates a result of the extraction of a block candidate for each functional module.

The architecture candidate extraction unit 150 extracts an architecture candidate on the basis of the block candidate extraction result 179 and the data input-output relation information 177.

That is, the architecture candidate extraction unit 150 generates a plurality of candidates for a computer architecture which implements the plurality of functions included in the function model source code 171, that is, candidates for the architecture of the embedded system, as architecture candidates. Note that the architecture candidates are different in a combination of block candidates.

The block candidate extraction unit 140 then generates an architecture candidate extraction result 180 which indicates the extracted architecture candidates.

The bus layer selection unit 191 selects a bus layer which satisfies the non-functional requirements from among a plurality of bus layers for an architecture candidate, in which two or more blocks (devices) are bus-connected, among the plurality of architecture candidates stored in the architecture candidate extraction result 180. More specifically, the bus layer selection unit 191 selects a bus layer which satisfies the non-functional requirements from a bus layer template 183. The bus layer selection unit 191 then generates bus layer selection result information 184 which indicates the selected bus layer.

The performance evaluation unit 160 evaluates the performance of each architecture candidate indicated in the architecture candidate extraction result 180. Note that the performance evaluation unit 160 evaluates the bus layer indicated in the bus layer selection result information 184 in terms of bus layers.

The performance evaluation unit 160 selects an architecture candidate which satisfies the non-functional requirements required for the architecture of the embedded system from among the plurality of architecture candidates extracted by the architecture candidate extraction unit 150.

The performance evaluation unit 160 then generates an architecture candidate selection result 181 which indicates the selected architecture candidate.

If there is no architecture candidate that satisfies the non-functional requirements, the performance evaluation unit 160 selects, as an approximate architecture candidate, an architecture candidate which does not satisfy the non-functional requirements but has attributes closest to the non-functional requirements among the plurality of architecture candidates generated by the block candidate extraction unit 140.

The performance evaluation unit 160 then notifies the block candidate extraction unit 140 of a difference between the attributes of the selected approximate architecture candidate and the non-functional requirements.

The existing architecture information acquisition unit 190 acquires existing architecture information 182 which is information on designed architectures from the user via the input device 905. The existing architecture information acquisition unit 190 then stores the existing architecture information 182 in the storage unit 170.

The existing architecture information 182 is used to generate the extraction rules 175.

The architecture generation apparatus 100 operates in collaboration with the high-level synthesis apparatus 200.

The high-level synthesis apparatus 200 automatically generates an RTL (Register Transfer Level) using a high-level language, such as the C language, the C++language, or the SystemC language, which is higher in the level of abstraction than RTL.

The high-level synthesis apparatus 200 can be implemented by, for example, a high-level synthesis tool which is commercially available.

The architecture generation apparatus 100 operates in collaboration with the software compiler 300.

The software compiler 300 outputs a binary file which is executable by a processor of a target embedded system from source code written in the C language or the like.

The software compiler 300 can be implemented by, for example, a compiler which is commercially available.

*** Description of Operation ***

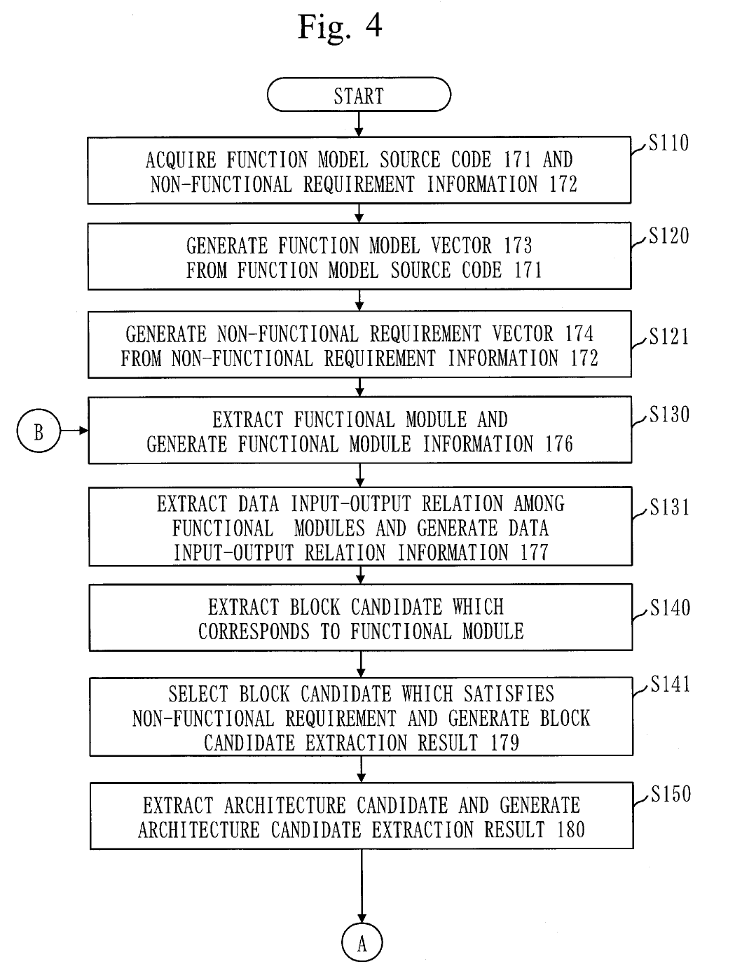

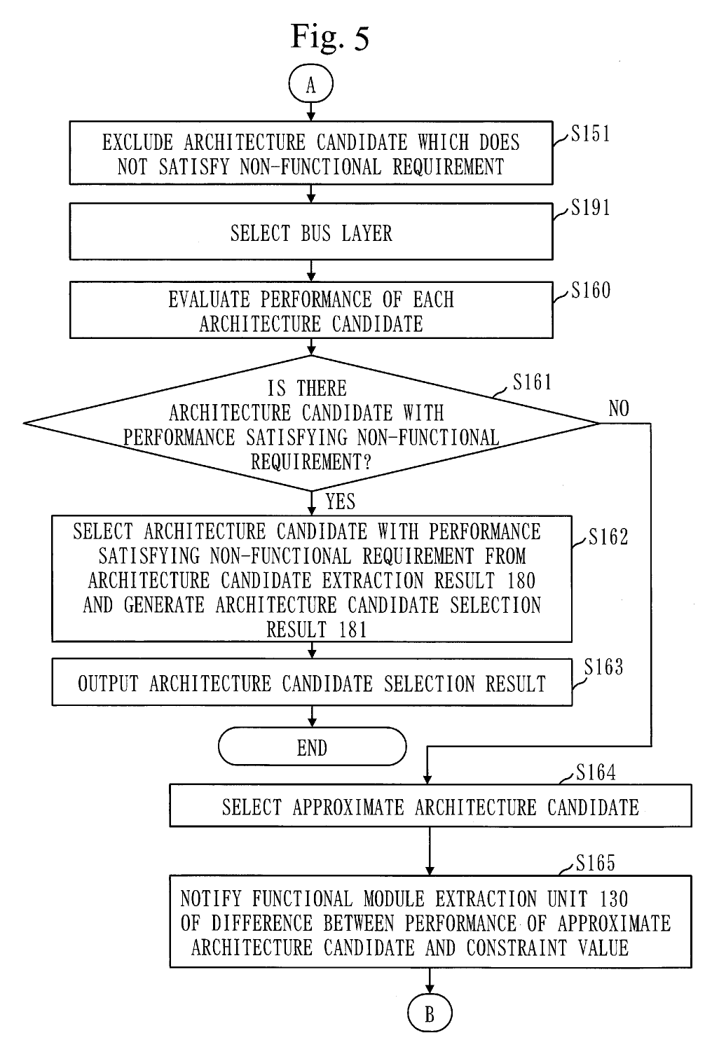

An example of operation of the architecture generation apparatus 100 according to the present embodiment will be described with reference to FIGS. 4 and 5.

In step S110, the source code acquisition unit 110 first acquires the function model source code 171 and the non-functional requirement information 172 from the user. The source code acquisition unit 110 then stores the acquired function model source code 171 and non-functional requirement information 172 in the storage unit 170.

The function model source code 171 is program code which describes processing functions/the system configuration of the embedded system in a program language (for example, the C language).

FIG. 6 illustrates an example of the function model source code 171.

As illustrated in FIG. 6, the function model source code 171 is identical to a common program. Variables corresponding to an external input and an external output from and to the system are pointed to by /*external_input*/ and /*external_output*/.

Note that ELEM0 to ELEM6 in FIG. 6 denote respective program elements. If there is no need to make a distinction among the program elements ELEM0 to ELEM6, each of the program elements ELEM0 to ELEM6 will hereinafter be referred to as a program element ELEMx.

As illustrated in FIG. 7, the non-functional requirement information 172 describes, as the non-functional requirements, a processing performance constraint, a circuit size constraint, and a power consumption constraint.

The processing performance constraint is the constraint that processes from a particular process to a different particular process are completed within a time limit of Tth [s].

The circuit size constraint is the constraint that circuit size is within Ath [Gates].

The power consumption constraint is the constraint that the power consumption of the whole embedded system implemented by the function model source code 171 is within Pth [W].

Note that a non-functional requirement other than the processing performance constraint, the circuit size constraint, and the power consumption constraint may be described in the non-functional requirement information 172. For example, a constraint on an external input and output interface or a constraint on hardware resources of an external memory may be described in the non-functional requirement information 172.

In step S120 of FIG. 4, the analysis unit 120 generates the function model vectors 173 from the function model source code 171.

More specifically, the analysis unit 120 divides the function model source code 171 into smallest division units. In the present embodiment, the analysis unit 120 divides the function model source code 171 into smallest division units based on the division conditions below and obtains a plurality of program elements.

(1) A unit for a program element is a range enclosed in a basic block ({ } in the case of the C language) (note that functions are all in-lined).
(2) If the function model source code 171 has a nest structure, a superior and a subordinate in a nest are regarded as respective program elements.
(3) If the number of arithmetic operations inside a basic block exceeds a threshold, all expressions referred to by a variable which is used as an output from the basic block are divided as one program element.

The analysis unit 120 then analyzes, for each program element ELEMx, at least any one of numerical parameters, such as the number of operators, the number of branches, the number of loops, the number of variables, and the number of data inputs and outputs included in the function model source code 171 and generates the function model vectors 173.

Here, the analysis unit 120 analyzes, for each program element ELEMx, the number of operators, the number of branches, the number of loops, the number of intermediate variables, and the number of data inputs and outputs included in the function model source code 171 and generates the function model vectors 173.

The analysis unit 120 extracts the parameters, for example, in the manner below.

### (1) Number of Operators

The analysis unit 120 obtains, for each program element, the numbers of “+”, “−”, “*”, “-”, and “<<” included in the program element.

Note that the analysis unit 120 does not separately count a product operator and a sum operator included in a product-sum operation but counts the operators as a product-sum operator. For example, the analysis unit 120 does not separately count “+” and “*” for the product-sum operation “y=a+b*c” but counts the operators as one product-sum operator.

The analysis unit 120 separately counts a multiplication operator included in a constant multiplication and a multiplication operator included in a variable multiplication. For example, the analysis unit 120 separately counts a multiplication operator in a constant multiplication (for example, y=a*3) and a multiplication operator in a variable multiplication (for example, y=a*b).

Similarly, the analysis unit 120 separately counts a division operator included in a constant division and a division operator included in a variable division.

### (2) Number of Branches

The analysis unit 120 obtains the number of if/else statements included in the function model source code 171. The analysis unit 120 obtains the total number of case statements if the function model source code 171 has a switch statement.

### (3) Number of Loops

The analysis unit 120 counts the number of loops of an outermost loop. Note that if the number of loops is variable, the analysis unit 120 obtains a maximum value.

### (4) Number of Intermediate Variables

The analysis unit 120 obtains, for each program element, the number of intermediate variables included in the program element. More specifically, the analysis unit 120 obtains the number of variables, which are not used in any other program element and to each of which a value is assigned after the variable is referred to in the program element.

The analysis unit 120 counts, for example, variables like tmp below.

```
      int tmp;
      for(int i=0;i<N;i++){
            out[i]=tmp;
            tmp=func(in[i]);
}
```

(5) Number of Inputs from Outside Embedded System

The analysis unit 120 obtains, for each program element, the total number of times a variable (variables) pointed to by /*external_input*/ is (are) referred to inside the program element.

### (6) Number of Outputs to Outside Embedded System

The analysis unit 120 obtains, for each program element, the total number of times an assignment is made to a variable (variables) pointed to by /*external_output*/ inside the program element.

(7) Number of Inputs from Different Function

The analysis unit 120 counts, for each program element, the number of variables, each of which is referred to inside the program element after an assignment is made to the variable in a different program element and is not an array.

The analysis unit 120 counts, for example, variables like val below.

```
      //different program element
{
      val=func1( );
}
      //program element in question
{
      func2(val+b);
}
```

### (8) Number of Outputs to Different Function

The analysis unit 120 counts, for each program element, the number of variables, each of which is referred to inside a different program element after an assignment is made to the variable inside the program element and is not an array. That is, the analysis unit 120 counts the number of variables which are opposite in pattern to those in (7) above.

### (9) Number of Inputs to Array

The analysis unit 120 extracts, for each program element, (a) the type of an array referred to in the program element, (b) the number of accesses to the array in the program element, and (c) a difference between an access index when the array is referred to in the program element and an access index when a value is assigned to the array in a program element executed earlier than the program element. Note that if the difference in access index is less than a threshold, the analysis unit 120 uses a predetermined maximum value as the difference in access index.

The analysis unit 120 extracts N as (b) the number of accesses and extracts (i+3)−i=3 as (c) the difference in access index, for example, in the case below.

```
      //different program element
      for(int i=0;i<N;i++){
            array[i]=i*i;
}
      //program element in question
      for(int i=0;i<N;i++){
            out[i]=array[i+3];
}
```

(10) Number of Outputs from Array

The analysis unit 120 extracts, for each program element, (a) the type of an array to which a value is assigned in the program element, (b) the number of accesses to the array in the program element, and (c) a difference between an access index when a value is assigned to the array in the program element and an access index when the array is referred to in a program element executed later than the program element. That is, the analysis unit 120 counts the number of variables which are opposite in pattern to those in (9) above.

### (11) Nesting Level

If the function model source code 171 is hierarchized, that is, if the function model source code 171 has a nest structure, the analysis unit 120 determines the level of nesting of each program element. The level of nesting will hereinafter be referred to as a nesting level.

FIG. 19 illustrates an example of the nesting level information 185 that indicates the nesting level of each program element extracted by the analysis unit 120. FIG. 19 is an example of the nesting level information 185 generated for the function model source code 171 in FIG. 6. The nesting level of ELEM0 that is a top-ranked program element is 0, and the nesting levels of ELEM1, ELEM2, and ELEM4 that are program elements subordinate thereto are 1. Although ELEM5 and ELEM6 are not included in a nest structure in the function model source code 171, since the number of arithmetic operations inside a basic block exceeds a threshold, ELEM5 and ELEM6 are divided from ELEM4. For this reason, ELEM5 and ELEM6 are treated as subordinate to ELEM4 in the hierarchy, and the nesting levels are 2.

### (12) Subordinate Program Element

The analysis unit 120 analyzes, for each program element, whether the program element has a subordinate program element.

FIG. 20 illustrates an example of the nest structure information 186 that indicates an analysis result from the analysis unit 120. In the nest structure information 186 in FIG. 20, “1” is set if a program element has a subordinate program element. Note that, in the nest structure information 186 in FIG. 20, “1” is set only for an immediately subordinate program element. For example, since ELEM0 has ELEM1, ELEM2, and ELEM4 as immediately subordinate program elements, “1” is set in rows for ELEM1, ELEM2, and ELEM4 in a row for ELEM0. Since ELEM3, ELEM5, and ELEM6 are not program elements immediately subordinate to ELEM0, “0” is set. In this manner, the analysis unit 120 parameterizes the nest structure of the function model source code 171.

FIG. 14 illustrates an example of the function model vectors 173 generated by the analysis unit 120.

In the function model vectors 173 in FIG. 14, only ELEM0 to ELEM3 are illustrated for reasons of illustration. However, the number of operators (addition, subtraction, constant multiplication, variable multiplication, constant division, variable division, assignment, and product-sum), the number of branches, the number of loops, the number of intermediate variables, and the number of data inputs and outputs are presented for each of the program elements ELEM0 to ELEM6.

Note that, in input-related fields, program elements as input sources are described in columns, and program elements as input destinations are described in rows. In output-related fields, program elements as output destinations are described in columns, and program elements as output sources are described in rows. In the example in FIG. 14, data is passed from the outside to the program element ELEM0. Data is passed from the program element ELEM0 to each of the program elements ELEM1 and ELEM2. Data is passed from each of the program elements ELEM1 and ELEM2 to the program element ELEM3.

Next, in step S121 of FIG. 4, the analysis unit 120 generates the non-functional requirement vectors 174 from the non-functional requirement information 172.

More specifically, the analysis unit 120 extracts constraint values from the non-functional requirement information 172 and generates the non-functional requirement vectors 174 using the extracted constraint values.

If the non-functional requirement information 172 illustrated in FIG. 7 is given, the analysis unit 120 generates the non-functional requirement vectors 174 as illustrated in FIG. 8.

Next, in step S130, the functional module extraction unit 130 groups the program elements ELEMx and generates the functional module information 176.

More specifically, the functional module extraction unit 130 applies the extraction rules 175 to the function model vectors 173, the nesting level information 185, the nest structure information 186, and the non-functional requirement vectors 174 and groups the plurality of program elements ELEMx included in the function model source code 171 under a plurality of functional modules. The functional module extraction unit 130 then generates the functional module information 176 that indicates a grouping result.

FIG. 9 illustrates an example of the functional module information 176 that is generated by the functional module extraction unit 130.

In the example in FIG. 9, the program elements ELEM0, ELEM4, ELEM5, and ELEM6 are classified under functional module 0. The program element ELEM1 is classified under functional module 1. The program elements ELEM2 and ELEM3 are classified under functional module 2.

Next, in step S131, the functional module extraction unit 130 analyzes a data input-output relation among the functional modules and generates the data input-output relation information 177 that indicates an analysis result.

More specifically, the functional module extraction unit 130 analyzes a data input situation and a data output situation for each program element indicated by the function model vector 173 and analyzes a data input-output relation among the functional modules indicated in the functional module information 176.

An example of the data input-output relation information is illustrated in (a) of FIG. 10. Also, (b) of FIG. 10 is a graphic representation of content indicated in the data input-output relation information in (a) of FIG. 10.

Next, in step S140, the block candidate extraction unit 140 extracts a block candidate which corresponds to a functional module.

More specifically, the block candidate extraction unit 140 extracts, for each functional module, a block which corresponds to the functional module as a block candidate among a plurality of blocks included in the block template 178.

A processor which executes software and dedicated hardware devices, such as an ASIC and an FPGA, are included as blocks in the block template 178.

The block template 178 includes the pieces of information below. Note that, in the following description, S/W refers to software while H/W refers to hardware.

(1) Processing type: S/W, H/W (pipeline), H/W (parallel), or H/W (sequential execution)
(2) Communication type: bus or direct connection
(3) Memory type: internal memory, external memory (volatile), or external memory (non-volatile)

The processing type in (1) above is a parameter for determining whether a device to implement a functional module is a processor which executes software or dedicated H/W. For example, H/W in which pipeline processing is performed, H/W in which parallel processing is performed, and H/W in which sequential processing is performed are defined as types of dedicated H/W for the processing type in (1) above.

The block candidate extraction unit 140 analyzes an input-output relation for each functional module indicated in the data input-output relation information 177 and extracts all blocks corresponding to each functional module as block candidates.

For example, in FIG. 10, data is input from the outside (an AXI slave) to functional module 0. The block candidate extraction unit 140 extracts all devices having an interface with the AXI slave as block candidates for functional module 0.

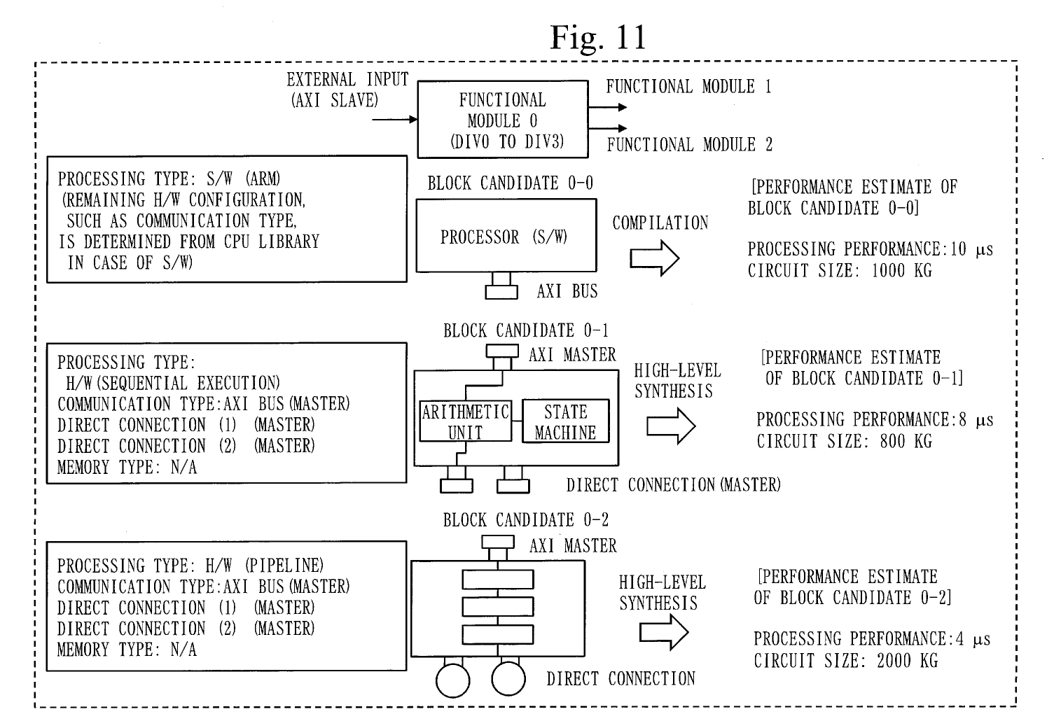

FIG. 11 illustrates an example of block candidates extracted by the block candidate extraction unit 140 for functional module 0.

In FIG. 11, block candidate 0-0, block candidate 0-1, and block candidate 0-2 are extracted.

Next, in step S141, the block candidate extraction unit 140 selects block candidates which satisfy the non-functional requirements indicated in the non-functional requirement information 172 from among a plurality of block candidates extracted in step S140. The block candidate extraction unit 140 then generates the block candidate extraction result 179 that indicates the selected block candidates.

More specifically, the block candidate extraction unit 140 subjects each block candidate, processing type of which is H/W, to high-level synthesis by the high-level synthesis apparatus 200 among the plurality of block candidates extracted in step S140. The block candidate extraction unit 140 obtains the performance, such as processing performance and circuit size, of the block candidate through the high-level synthesis by the high-level synthesis apparatus 200. The block candidate extraction unit 140 then determines, for each block candidate, whether the performance obtained through the high-level synthesis satisfies the non-functional requirements in the non-functional requirement information 172. The block candidate extraction unit 140 selects each block candidate, performance of which satisfies the non-functional requirements, and generates the block candidate extraction result 179 that indicates the selected block candidates.

The block candidate extraction unit 140 subjects each block candidate, processing type of which is S/W, to high-level synthesis by the software compiler 300 among the plurality of block candidates extracted in step S140. The block candidate extraction unit 140 obtains the number of instruction executions and the number of clocks through the high-level synthesis by the software compiler 300. The block candidate extraction unit 140 then calculates processing performance from the number of instructions executed×the number of clocks. The block candidate extraction unit 140 determines, for each block candidate, whether the calculated processing performance satisfies the non-functional requirements. The block candidate extraction unit 140 selects each block candidate, performance of which satisfies the non-functional requirements, and generates the block candidate extraction result 179 that indicates the selected block candidates.

Next, in step S150, the architecture candidate extraction unit 150 connects the block candidates selected in step S141 and extracts an architecture candidate.

More specifically, the architecture candidate extraction unit 150 connects block candidates indicated in the block candidate extraction result 179 in accordance with the input-output relation indicated in the data input-output relation information 177. At this time, the architecture candidate extraction unit 150 connects the block candidates so as not to contradict the communication type of each block candidate. For example, the architecture candidate extraction unit 150 connects a block candidate, communication type of which is bus, to a bus.

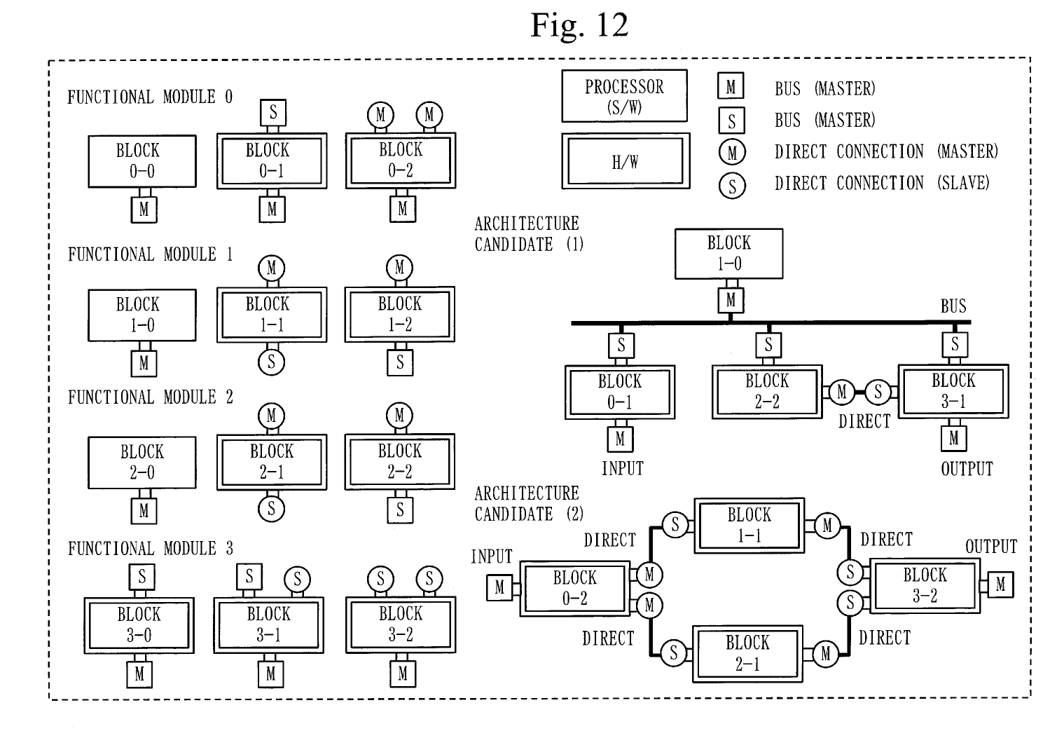

FIG. 12 illustrates an example of architecture candidates.

In the example in FIG. 12, block candidate 0-0, block candidate 0-1, and block candidate 0-2 are selected for functional module 0. For functional module 1, block candidate 1-0, block candidate 1-1, and block candidate 1-2 are selected. For functional module 2, block candidate 2-0, block candidate 2-1, and block candidate 2-2 are selected. For functional module 3, block candidate 3-0, block candidate 3-1, and block candidate 3-2 are selected. Note that a “block candidate” is simply referred to as a “block” in FIG. 12 for reasons of illustration.

Although only two architecture candidates are illustrated for reasons of illustration in FIG. 12, the architecture candidate extraction unit 150 extracts architecture candidates corresponding to all block candidate combinations, each of which does not contradict the communication type of each block candidate.

As described above, the architecture candidate extraction unit 150 extracts a plurality of architecture candidates which are different in a combination of block candidates.

Next, in step S151 of FIG. 5, the architecture candidate extraction unit 150 excludes an architecture candidate which does not satisfy the non-functional requirements from the architecture candidates extracted in step S150.

More specifically, the architecture candidate extraction unit 150 excludes an architecture candidate which meets the conditions below if the non-functional requirement information 172 includes the processing performance constraint Tth, the circuit size constraint Ath, and the power consumption constraint Pth, as illustrated in FIG. 7.

(1) The total sum of latency times of blocks associated with Tth>Tth
(2) The total sum of the circuit sizes of blocks>Ath
(3) The total sum of the power consumption of the blocks>Pth

The architecture candidate extraction unit 150 then generates the architecture candidate extraction result 180 that indicates architecture candidates left after step S150.

Next, in step S191, the bus layer selection unit 191 selects a bus layer.

More specifically, if an architecture candidate, in which two or more blocks (devices) are bus-connected, is included in the architecture candidate extraction result 180, the bus layer selection unit 191 selects a bus layer, which satisfies the processing performance constraint Tth of the non-functional requirement information 172 and is smallest in circuit size, for the architecture candidate from the bus layer template 183. The bus layer selection unit 191 then generates the bus layer selection result information 184 that indicates the selected bus layer.

Bus connection pattern information, such as crossbar or ring bus, and a corresponding bus standard are stored in the bus layer template 183.

An example of a bus layer selection method by the bus layer selection unit 191 will be illustrated.

If a bus which connects two or more blocks is an AXI bus, the bus layer selection unit 191 connects all masters and slaves with crossbars so as to achieve highest speed as a default value. With this connection, the bus layer selection unit 191 then measures a processing time period for a portion in an architecture candidate which is a target for the processing performance constraint Tth of the non-functional requirement information 172 through software/hardware co-simulation. If the measured processing time period satisfies the processing performance constraint Tth, the bus layer selection unit 191 makes a switch to a common bus in a path with least data transfer in the architecture candidate and measures a processing time period again through software/hardware co-simulation. The bus layer selection unit 191 searches for a bus layer which satisfies the processing performance constraint Tth and is smallest in circuit size by repeating the above-described procedure.

Next, in step S160, the performance evaluation unit 160 evaluates the performance of each architecture candidate.

More specifically, the performance evaluation unit 160 executes software/hardware co-simulation for each architecture candidate in the architecture candidate extraction result 180 and obtains the performance (for example, processing performance and circuit size) of the architecture candidate. Note that, at this time, a bus layer (a bus layer selected in step S191) indicated in the bus layer selection result information 184 generated in step S191 is used in the case of bus connection.

In step S161, the performance evaluation unit 160 determines, for each architecture candidate, whether the performance obtained through software/hardware co-simulation satisfies the non-functional requirements of the non-functional requirement information 172.

If there is any architecture candidate with performance satisfying the non-functional requirements (YES in step S161), the performance evaluation unit 160 selects an architecture candidate with performance satisfying the non-functional requirements from the architecture candidate extraction result 180 in step S162. The performance evaluation unit 160 then generates the architecture candidate selection result 181 that indicates the selected architecture candidate.

Next, in step S163, the performance evaluation unit 160 outputs the architecture candidate selection result 181 generated in step S162 to, for example, the display 906.

The architecture generation apparatus 100 ends the process.

On the other hand, if there is no architecture candidate with performance satisfying the non-functional requirements (NO in step S161), the performance evaluation unit 160 selects an approximate architecture candidate which is smallest in a difference between the performance and the non-functional requirements in step S164.

More specifically, the performance evaluation unit 160 calculates, for each architecture candidate, an absolute value of a difference between the performance obtained in step S160 and each of the constraint values in the non-functional requirement information 172 and selects, as an approximate architecture candidate, an architecture candidate which is smallest in the sum of the calculated absolute values.

Assume here that the processing performance constraint Tth and the circuit size constraint Ath are given as non-functional requirements. Also, assume that the number of architecture candidates described in the architecture candidate extraction result 180 is N (N≥2), the processing performance of an architecture candidate x (x is 1 to N) is processing performance Tx, and the circuit size of the architecture candidate x is circuit size Ax. The performance evaluation unit 160 selects an architecture candidate x which is smallest in a value of |Tth31 Tx|+|Ath−Ax| as an approximate architecture candidate.

Next, in step S165, the performance evaluation unit 160 notifies the functional module extraction unit 130 of a difference between the performance of the approximate architecture candidate selected in step S164 and the constraint values.

That is, the performance evaluation unit 160 notifies the functional module extraction unit 130 of |Tth−Tx| and |Ath−Ax| described earlier for the architecture candidate x selected in step S164.

Next, in step S130, the functional module extraction unit 130 updates the non-functional requirement vectors 174 on the basis of the difference (for example, |Tth−Tx| and |Ath−Ax|), of which the functional module extraction unit 130 is notified by the performance evaluation unit 160 in step S165.

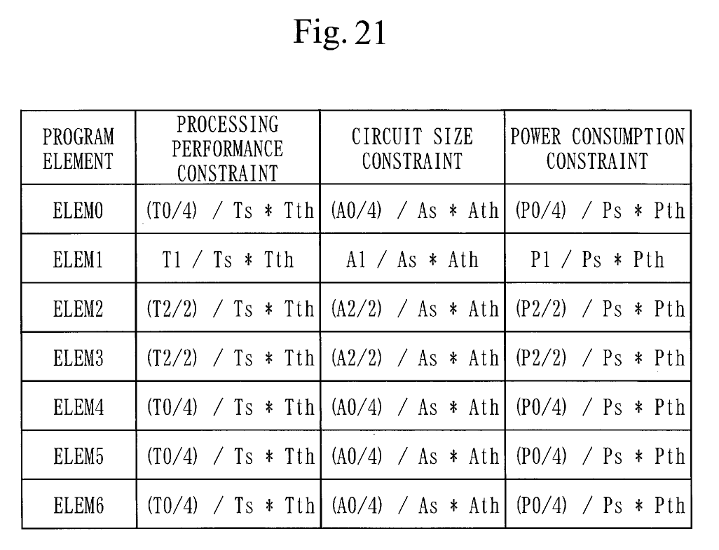

FIG. 21 illustrates an example of the updated non-functional requirement vectors 174.

The functional module extraction unit 130 then performs machine learning based on, for example, an algorithm for supervised learning or an algorithm for regression analysis using non-functional requirement feedback information after the update and changes the extraction rules 175. The functional module extraction unit 130 then groups the program elements ELEM0 to ELEM6 included in the function model source code 171 using the extraction rules 175 after the change to obtain new functional modules.

After that, the processes in step S131 and subsequent steps are performed for the new functional modules.

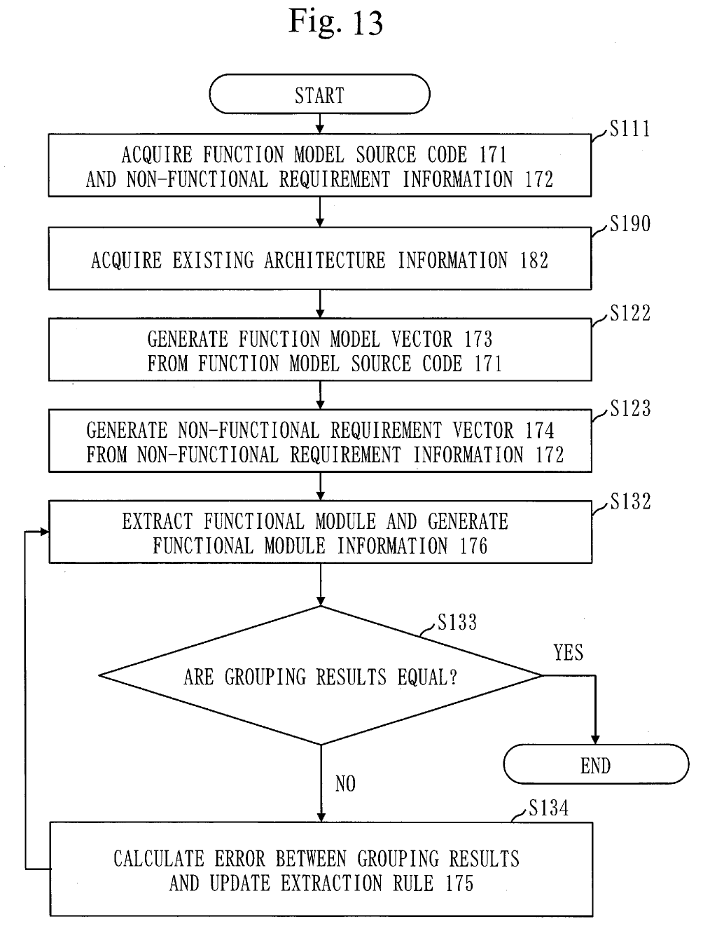

A procedure by which the functional module extraction unit 130 generates the extraction rules 175 through machine learning will be described with reference to FIG. 13.

Note that a procedure by which the functional module extraction unit 130 performs machine learning (for example, deep learning) using the existing architecture information 182 that indicates a designed existing architecture to generate the extraction rules 175 will be illustrated below.

Note that the existing architecture is, for example, an architecture which is manually designed by a designer.

Assume here that an architecture illustrated in FIG. 16 is the existing architecture.

An embedded system for which the existing architecture is designed is referred to as an existing embedded system.

Assume that the existing embedded system includes the program elements ELEM0 to ELEM3, as illustrated in FIG. 16.

In the existing architecture in FIG. 16, the program element ELEM0 is classified under functional module 0. The program element ELEM1 is classified under functional module 1. The program elements ELEM2 and ELEM3 are classified under functional module 2. Functional module 0 is implemented by a processor, functional module 1 is implemented by dedicated hardware 1, and functional module 2 is implemented by dedicated hardware 2. The processor, dedicated hardware 1, and dedicated hardware 2 are connected to an AXI bus.

If there is no need to make a distinction among the program elements ELEM0 to ELEM3, each of the program elements ELEM0 to ELEM3 will hereinafter be referred to as a program element ELEMx.

In step S111 of FIG. 13, the source code acquisition unit 110 acquires the function model source code 171 and the non-functional requirement information 172. The function model source code 171 and the non-functional requirement information 172 acquired in step S111 are the function model source code 171 and the non-functional requirement information 172 for the existing embedded system.

Note that since an acquisition procedure in step S111 is the same as described in step S110 of FIG. 4, a description of the acquisition procedure in step S111 will be omitted.

Next, in step S190, the existing architecture information acquisition unit 190 acquires the existing architecture information 182 for the existing embedded system and stores the existing architecture information 182 in the storage unit 170.

As illustrated in FIG. 16, the existing architecture information 182 includes the pieces of information below.

(1) Information (information corresponding to the functional module information 176) indicating a result of grouping program elements included in the function model source code 171 for the existing embedded system
(2) Information (information corresponding to the architecture candidate extraction result 180) on a block configuration in the existing architecture and connection among blocks

Next, in step S122, the analysis unit 120 generates the function model vectors 173 from the function model source code 171 for the existing embedded system acquired in step S111.

Note that since a procedure for generating the function model vectors 173 in step S122 is the same as described in step S120 of FIG. 4, a description thereof will be omitted.

Next, in step S123, the analysis unit 120 generates the non-functional requirement vectors 174 from the non-functional requirement information 172 for the existing embedded system acquired in step S111.

Note that since a procedure for generating the non-functional requirement vectors 174 in step S123 is the same as described in step S121 of FIG. 4, a description thereof will be omitted.

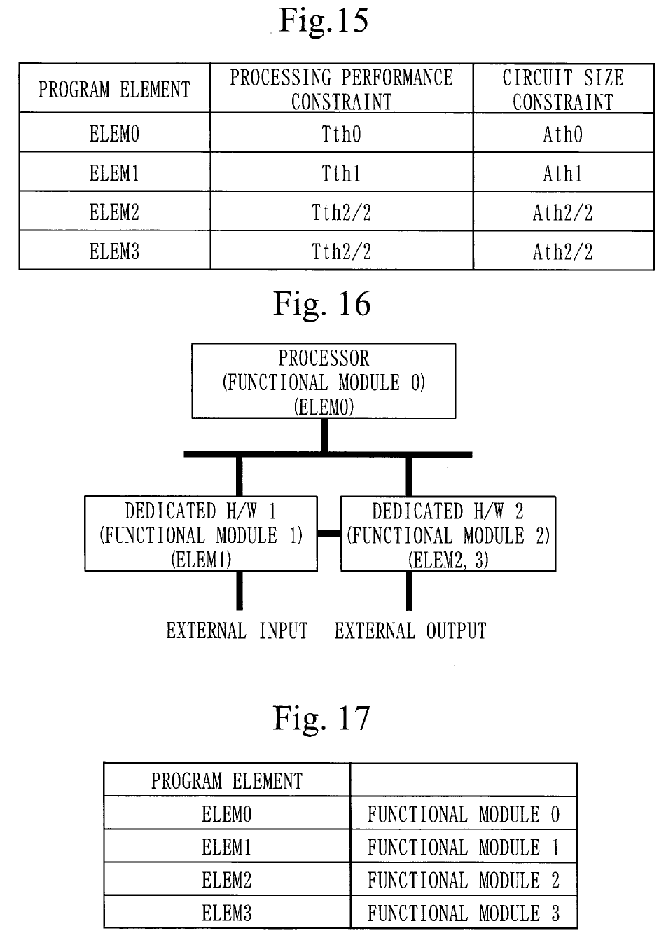

Note that FIG. 15 illustrates an example of the non-functional requirement vectors 174 generated in step S123. In FIG. 15, Tth0, Tth1, and Tth2 denote respective processing performance constraint values for the existing architecture and the processor (ELEM0), dedicated hardware 1 (ELEM1), and dedicated hardware 2 (ELEM2 and ELEM3) illustrated in FIG. 16. Also, Ath0, Ath1, and Ath2 denote respective circuit size constraint values for the existing architecture and the processor (ELEM0), dedicated hardware 1 (ELEM1), and dedicated hardware 2 (ELEM2 and ELEM3) illustrated in FIG. 16. Since ELEM2 and ELEM3 are classified under one functional module (functional module 2), the constraint values Tth2 and Ath2 are divided between ELEM2 and ELEM3 (divided by two in this example).

Next, in step S132, the functional module extraction unit 130 groups the program elements ELEMx of the existing embedded system on the basis of the extraction rules 175 and generates the functional module information 176. Note that a procedure for generating the functional module information 176 in step S132 is the same as described in step S130 of FIG. 4 and that a description thereof will be omitted.

Next, in S133, the functional module extraction unit 130 determines whether or not a grouping result obtained in step S132 is equal to a grouping result included in the existing architecture information 182.

If the grouping results are equal (YES in step S133), the functional module extraction unit 130 ends the process.

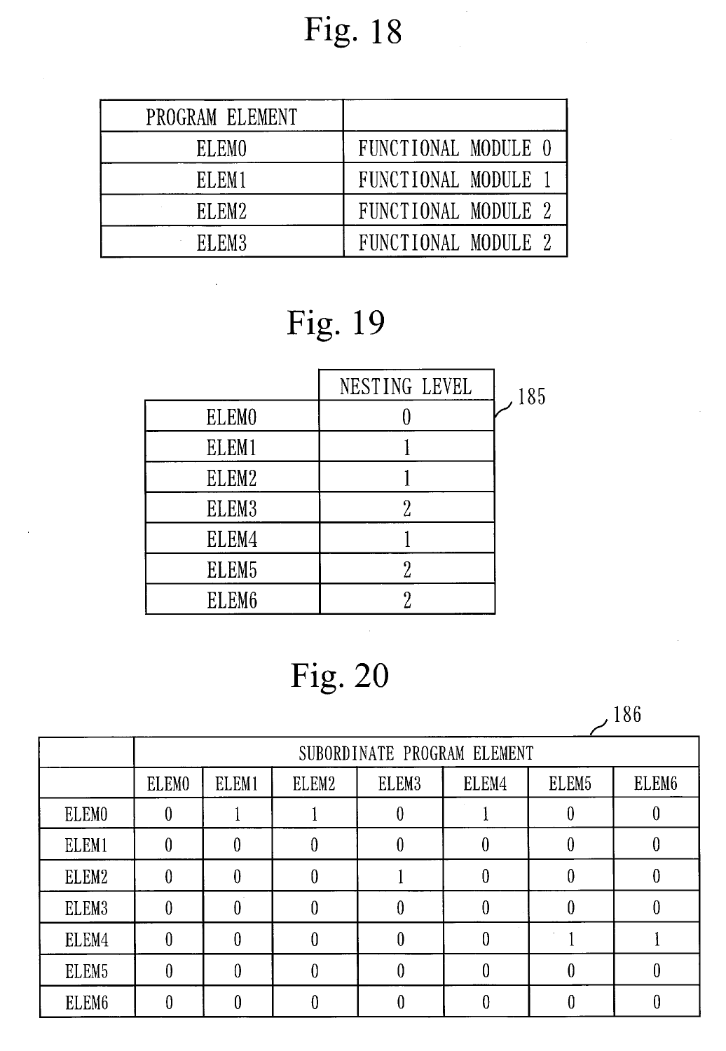

For example, if a grouping result illustrated in FIG. 18 is obtained in step S132, the grouping result is equal to the grouping result illustrated in FIG. 16, and the functional module extraction unit 130 ends the process.

On the other hand, if the grouping results do not coincide with each other (NO in step S133), the functional module extraction unit 130 regards the grouping result (vectors) for the existing architecture stored in the existing architecture information 182 as a correct answer in step S134 and calculates an error from the grouping result (vectors) in the functional module information 176 generated in step S132.

For example, if a grouping result illustrated in FIG. 17 is obtained, the grouping result is not equal to the grouping result illustrated in FIG. 16, and the functional module extraction unit 130 calculates an error.

The functional module extraction unit 130 then updates the extraction rules 175 using the calculated error on the basis of an algorithm for common supervised learning or an algorithm for regression analysis.

After step S134, the functional module extraction unit 130 groups the program elements ELEMx using the extraction rules 175 after the update and generates the new functional module information 176 in step S132. After that, step S133, step S134, and step S132 are repeated until the grouping results coincide with each other.

For example, if a grouping result in the functional module information 176 generated in step S132 is as illustrated in FIG. 17, the functional module extraction unit 130 changes the extraction rules 175 through machine learning such that the grouping result illustrated in FIG. 18 is obtained.

As described above, the functional module extraction unit 130 analyzes a relation which can be read from parameters described in the function model vectors 173. The functional module extraction unit 130 then controls machine learning parameters on the basis of an analysis result so as to reduce an error between a grouping result obtained through the extraction rules 175 and a grouping result as a correct answer. This allows the functional module extraction unit 130 to generate the extraction rules 175, from which the same architecture as that manually generated by a designer can be acquired.

The functional module extraction unit 130 learns a plurality of existing architectures, thereby generalizing the extraction rules 175. Even when a function model and non-functional requirements without an existing architecture are given, appropriate grouping can be performed.

*** Description of Advantageous Effects of Embodiment ***

In the present embodiment described above, attributes of each functional module and a hierarchy of a plurality of functional modules are extracted through functional module analysis, and machine learning is performed on the basis of the extracted attributes of the functional modules and the extracted hierarchy of the plurality of functional modules. For this reason, the present embodiment allows improvement of the accuracy of machine learning.

Note that the present invention is not limited to the present embodiment and that various changes can be made, as needed.

For example, the functional configuration of the architecture generation apparatus 100 may be different from that in FIG. 1.

An operation procedure for the architecture generation apparatus 100 may be different from that illustrated in FIGS. 4 and 5.

*** Description of Hardware Configuration ***

Finally, a supplemental explanation of the hardware configuration of the architecture generation apparatus 100 will be given.

The processor 901 illustrated in FIG. 3 is an IC (Integrated Circuit) which performs processing.

The processor 901 is a CPU (Central Processing Unit), a DSP (Digital Signal Processor), or the like.

The auxiliary storage device 902 is a ROM (Read Only Memory), a flash memory, an HDD (Hard Disk Drive), or the like.

The memory 903 is a RAM (Random Access Memory).

The communication device 904 is, for example, a communication chip or an NIC (Network Interface Card).

The auxiliary storage device 902 also stores an OS (Operating System).

At least a part of the OS is then loaded into the memory 903 and executed by the processor 901.

The processor 901 executes a program which implements functions of the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191 while executing at least a part of the OS.

The processor 901 executes the OS, thereby performing task management, memory management, file management, communication control, and the like.

Information, data, signal values, and variable values indicating results of processing by the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191 are stored in at least any of the auxiliary storage device 902, the memory 903, and a register and a cache memory inside the processor 901.

The program that implements the functions of the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191 may be stored in a portable storage medium, such as a magnetic disk, a flexible disk, an optical disc, a compact disc, a Blu-ray (a registered trademark) disc, or a DVD.

The “unit” in each of the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191 may be replaced with the “circuit”, the “step”, the “procedure”, or the “process”.

The architecture generation apparatus 100 may be implemented as an electronic circuit, such as a logic IC (Integrated Circuit), a GA (Gate Array), an ASIC, or an FPGA.

In this case, the source code acquisition unit 110, the analysis unit 120, the functional module extraction unit 130, the block candidate extraction unit 140, the architecture candidate extraction unit 150, the performance evaluation unit 160, the existing architecture information acquisition unit 190, and the bus layer selection unit 191 are each implemented as a portion of the electronic circuit.

Note that the processors and the above-described electronic circuits are also generically called processing circuitries.

### REFERENCE SIGNS LIST

100: architecture generation apparatus; 110: source code acquisition unit; 120: analysis unit; 130: functional module extraction unit; 140: block candidate extraction unit; 150: architecture candidate extraction unit; 160: performance evaluation unit; 170: storage unit; 171: function model source code; 172: non-functional requirement information; 173: function model vector; 174: non-functional requirement vector; 175: extraction rule; 176: functional module information; 177: data input-output relation information; 178: block template; 179: block candidate extraction result; 180: architecture candidate extraction result; 181: architecture candidate selection result; 182: existing architecture information; 183: bus layer template; 184: bus layer selection result information; 185: nesting level information; 186: nest structure information; 190: existing architecture information acquisition unit; 191: bus layer selection unit; 200: high-level synthesis apparatus; 300: software compiler; 901: processor; 902: auxiliary storage device; 903: memory; 904: communication device; 905: input device; 906: display

1. An information processing apparatus comprising:
processing circuitry
to divide hierarchized program code into two or more program elements in accordance with a predetermined division condition, and when the number of arithmetic operations in a program element among the two or more program elements exceeds a threshold, to redivide the program element into two or more program elements by treating all expressions using a common variable among variables used for an output of the program element as one program element, to analyze each of a plurality of program elements obtained by division and redivision, and to extract an attribute of each program element and a hierarchy of the plurality of program elements; and
to perform machine learning on the basis of the attribute of each program element and the hierarchy of the plurality of program elements extracted and to group the plurality of program elements into a plurality of groups.

2. The information processing apparatus according to claim 1, wherein
the processing circuitry extracts, for each program element, type of an array referred to in the program element, the number of accesses to the array in the program element, and a difference between an access index when the array is referred to in the program element and an access index when a value is assigned to the array in a program element which is executed earlier than the program element, as the attribute of the program element.

3. The information processing apparatus according to claim 1,
wherein
the processing circuitry extracts, for each program element, type of an array to which a value is assigned in the program element, the number of accesses to the array in the program element, and a difference between an access index when the value is assigned to the array in the program element and an access index when the array is referred to in a program element which is executed later than the program element, as the attribute of the program element.

4. The information processing apparatus according to claim wherein
the processing circuitry extracts at least any one of the number of operators, the number of branches, the number of loops, the number of variables, and the number of data inputs and outputs included in each program element, as the attribute of the program element.

5. The information processing apparatus according to claim 4, wherein
at the time of extracting the number of operators included in each program element, the processing circuitry
does not separately count a product operator and a sum operator included in a product-sum operation but counts the operators as a product-sum operator,
separately counts a multiplication operator included in a constant multiplication and a multiplication operator included in a variable multiplication, and
separately counts a division operator included in a constant division and a division operator included in a variable division.

6. The information processing apparatus according to claim 1, wherein
the processing circuitry selects a bus layer which satisfies a constraint condition among a plurality of bus layers, for an architecture candidate in which two or more devices are bus-connected among a plurality of architecture candidates generated as candidates for a computer architecture which implements the program code on the basis of a grouping result.

7. An information processing method comprising:
dividing hierarchized program code into two or more program elements in accordance with a predetermined division condition, and when the number of arithmetic operations in a program element among the two or more program elements exceeds a threshold, to redivide the program element into two or more program elements by treating all expressions using a common variable among variables used for an output of the program element as one program element, analyzing each of a plurality of program elements obtained by division and redivision, and extracting an attribute of each program element and a hierarchy of the plurality of program elements; and
performing machine learning on the basis of the extracted attribute of each program element and the extracted hierarchy of the plurality of program elements and grouping the plurality of program elements into a plurality of groups.

8. A non-transitory computer readable medium storing an information processing program that causes a computer to execute:
an analysis process of dividing hierarchized program code into two or more program elements in accordance with a predetermined division condition, and when the number of arithmetic operations in a program element among the two or more program elements exceeds a threshold, to redivide the program element into two or more program elements by treating all expressions using a common variable among variables used for an output of the program element as one program element, analyzing each of a plurality of program elements obtained by division and redivision, and extracting an attribute of each program element and a hierarchy of the plurality of program elements; and
a grouping process of performing machine learning on the basis of the attribute of each program element and the hierarchy of the plurality of program elements extracted by the analysis process and grouping the plurality of program elements into a plurality of groups.
